(19) United States
(12) Patent Application Publication
(10) Pub. No.: US 2015/0107194 A1
(43) Pub. Date: Apr. 23, 2015

(54) POLYCHLOROTRIFLUOROETHYLENE FILM AND PRODUCTION METHOD THEREOF

(71) Applicant: DAIKIN INDUSTRIES, LTD., Osaka (JP)

(72) Inventors: Tatsuya HIGUCHI, Osaka (JP); Toshiaki MASUI, Osaka (JP); Hidenori OZAKI, Osaka (JP); Shinya MURAKAMI, Osaka (JP); Takeshi INABA, Osaka (JP)

(73) Assignee: DAIKIN INDUSTRIES, LTD., Osaka (JP)

(21) Appl. No.: 14/517,221

(22) Filed: Oct. 17, 2014

(30) Foreign Application Priority Data
Oct. 18, 2013 (JP) 2013-217629

(51) Int. Cl. C08J 5/18; B29C 47/88; B29C 47/00

(52) U.S. Cl. CPC C08J 5/18; B29C 47/0021; B29C 47/8845; B29K 2085/00
USPC 53/453; 264/176.1; 526/249

(57) ABSTRACT

There is provided a method for producing a PCTFE film having excellent moisture resistance, good tensile elongation, and excellent formability. Provided is a method for producing a polychlcrotrifluoroethylene film, the method including step (1) of melting and molding polychlorotrifluoroethylene into a film, step (2) of maintaining the formed film at a temperature of 100° C. to 170° C., and step (3) of cooling the film to room temperature after the maintaining, wherein the temperature of the film is not allowed to be 170° C. or lower during an interval between step (1) and step (2).

### TECHNICAL FIELD

The present invention relates to a polychlorotrifluoroethylene film and a production method thereof.

### BACKGROUND ART

A polychlorotrifluoroethylene (PCTFE) film, which characteristically has low water vapor permeability, has been used, for example, as a coating sealant for electroluminescence (EL) devices, or as a moisture-resistant coating material or packaging material for electrical components, electronic components, medical materials, chemical agents, food products, and the like.

As a method for improving moisture resistance of the PCTFE film, a method for increasing the crystallinity of the film is known. However, an increase in the crystallinity of the film causes problems such as a decrease in mechanical strength and transparency of the film.

Patent Literature 1 discloses a method for producing a PCTFE-stretched film having relatively low water vapor permeability even at a low crystallinity, the method including melt-extruding PCTFE in a temperature range of 250° C. to 320° C., stretching the resulting sheet-like material at an elongation temperature of 50° C. to 85° C. and at an area draw ratio of at least three times, and heat-setting the resulting preform in a temperature range of 120° C. to 230° C.

### CITATION LIST

### Patent Literature

Patent Literature 1: JP-A H08-39664

### SUMMARY OF INVENTION

### Technical Problem

For use as various packaging materials, PCTFE films need to be moisture-resistant and easily formable according to the shape of an item to be packaged. The PCTFE film obtained by the production method disclosed in Patent Literature 1 had improved moisture resistance; however, it unfortunately exhibited low tensile elongation and poor formability.

The present invention was achieved in view of the above situation, and aims to provide a method for producing a PCTFE film having excellent moisture resistance, good tensile elongation, and excellent formability.

The present invention also aims to provide a PCTFE film excellent in moisture resistance, formability, and conformability to the shape of a mold.

### Solution to Problem

As a result of study of a method for producing a PCTFE film by melt-molding PCTFE, the present inventors found that a film having excellent tensile elongation can be produced by not allowing the temperature of a film obtained by melt-molding PCTFE to be 170° C. or lower and that a film having a high crystallinity and excellent moisture resistance can be produced by maintaining the temperature of the formed PCTFE film at 100° C. to 170° C., and the present invention was accomplished.

In other words, the present invention provides a method for producing a polychlorotrifluoroethylene film, the method including step (1) of melting and molding polychlorotrifluoroethylene into a film, step (2) of maintaining the formed film at a temperature of 100° C. to 170° C., and step (3) of cooling the film to room temperature after the maintaining, wherein the temperature of the film is not allowed to be 170° C. or lower during an interval between step (1) and step (2).

The maintaining in step (2) is preferably performed by contacting the formed film with a cooling roll.

The present invention also provides a polychlorotrifluoroethylene film, wherein the film has a crystallinity of 35 to 75%, a tensile elongation in its machine direction of 25% or more, and a tensile elongation in its transverse direction of 25% or more.

The polychlorotrifluoroethylene film is preferably a blister packaging film.

The present invention also provides a method for producing a blister pack, the method including the following steps after producing polychlorotrifluoroethylene by the above production method: step (4) of forming the polychlorotrifluoroethylene film into a bottom member including a depressed portion for holding contents in the film; and step (5) of bonding the bottom member and a lid member after the contents are placed in the depressed portion of the bottom member.

### Advantageous Effects of Invention

The method for producing a polychlorotrifluoroethylene film of the present invention can produce a film excellent in moisture resistance and formability.

The polychlorotrifluoroethylene film of the present invention has the above-described features, so that the film is excellent in moisture resistance, formability, and conformability to the shape of a mold.

The method for producing a blister pack of the present invention has the above-described features, so that the produced blister pack has excellent moisture resistance and can hold the contents of any shape, and the method is excellent in productivity because the step of forming a bottom member does not involve breakage of the film.

### BRIEF DESCRIPTION OF DRAWINGS

FIG. 1 is a view schematically showing one example of a method for producing a PCTFE film of the present invention.

FIG. 2 is a view schematically showing one example of a method for producing a PCTFE film of the present invention.

FIG. 3 is a view schematically showing one example of a method for producing a PCTFE film of the present invention.

### DESCRIPTION OF EMBODIMENTS

The present invention is described in detail below.

The present invention provides a method for producing a polychlorotrifluoroethylene film, the method including step (1) of melting and molding polychlorotrifluoroethylene into a film, step (2) of maintaining the film at a temperature of 100° C. to 170° C., and step (3) of cooling the film to room temperature after the maintaining, wherein the temperature of the film is not allowed to be 170° C. or lower during an interval between step (1) and step (2).

Thus, the method can produce a PCTFE film having low water vapor permeability, excellent moisture resistance, good tensile elongation, and excellent formability.

The method for producing a PCTFE film of the present invention includes step (1) of melting and molding polychlorotrifluoroethylene (PCTFE) into a film.

Examples of the PCTFE used in the present invention include a homopolymer of chlorotrifluoroethylene (CTFE) and a copolymer of a polymerization unit based on CTFE (CTFE unit) and a polymerization unit based on a monomer (a) polymerizable with CTFE (monomer (α) unit).

The PCTFE preferably contains 90 to 100 mol % of CTFE unit. For higher moisture resistance, an amount of 98 to 100 mol % of CTFE unit is more preferred, and an amount of 99 to 100 mol % of CTFE unit is still more preferred.

In the case where the PCTFE is a copolymer of the CTFE unit and the monomer (α) unit, the monomer (α) may be any monomer copolymerizable with the CTFE. Examples thereof include tetrafluoroethylene (TFE), ethylene (Et), vinylidene fluoride (VdF), perfluoro(alkylvinyl)ether (PAVE), a vinyl monomer represented by the following formula (I):

CX³X⁴═CX¹(CF₂)ₙX² (I)

(in the formula, X¹, X³, and X⁴ are the same or different and each represent a hydrogen atom or a fluorine atom; X² represents a hydrogen atom, a fluorine atom, or a chlorine atom; and n represents an integer of 1 to 10), and an alkyl perfluorovinyl ether derivative represented by the following formula (II):

CF₂═CF—OCH₂—RF (II)

(in the formula, Rf represents a C₁-C₅ perfluoroalkyl group).

Examples of the PAVE include perfluoro (methylvinylether) (PMVE), perfluoro(ethylvinylether) (PEVE), perfluoro(propylvinylether) (PPVE), and perfluoro(butylvinylether).

The vinyl monomer represented by the above formula (I) is not particularly limited. Examples thereof include hexafluoropropylene (HFP), perfluoro(1,1,2-trihydro-1-hexene), perfluoro(1,1,5-trihydro-1-pentene), and a perfluoro(alkyl)ethylene represented by the following formula (III):

H₂C═CX⁵Rf⁵ (III)

(in the formula, X⁵ represents H, F, or CF₃; and Rf⁵ represents a C₁-C₁₀ perfluoroalkyl group).

The perfluoro(alkyl)ethylene is preferably a perfluoro(butyl)ethylene.

The alkyl perfluorovinyl ether derivative represented by the above formula (II), wherein Rf is a C₁-C₃ perfluoroalkyl group, is preferred, and CF₂═CF—OCH₂—CF₂CF₃ is more preferred.

The monomer (α) polymerizable with the CTFE is preferably at least one selected from the group consisting of TFE, Et, VdF, PAVE, and any vinyl monomer represented by the above formula (I).

The monomer (α) may be used alone or in combination of two or more thereof.

The monomer (α) may also be an unsaturated carboxylic acid polymerizable with CTFE.

The unsaturated carboxylic acid is not particularly limited. Examples thereof include C₃-C₆ unsaturated aliphatic carboxylic acids such as (meth)acrylic acid, crotonic acid, maleic acid, fumaric acid, itaconic acid, citraconic acid, mesaconic acid, and aconitic acid, and may also include C₃-C₆ unsaturated aliphatic polycarboxylic acids.

The unsaturated aliphatic polycarboxylic acid is not particularly limited. Examples thereof include maleic acid, fumaric acid, itaconic acid, citraconic acid, mesaconic acid, and aconitic acid, and may also include acid anhydrides of acids such as maleic acid, itaconic acid, and citraconic acid that can be converted into their anhydrides.

The monomer (α) may be used in combination of two or more thereof; yet in the case where one is VdF, PAVE and/or HFP, there is no need to use itaconic acid, citraconic acid, or their anhydrides in combination.

The PCTFE preferably has a melt flow rate (MFR) of at least 0.1 g/10 min. The MFR is more preferably 1 g/10 min or more. The upper limit of the MFR is, for example, 20 g/10 min.

The MFR is a value that can be determined at a temperature of 265° C. and at a load of 10.0 kg in accordance with ASTM D3307.

The PCTFE preferably has a melting point of 210° C. to 216° C. The PCTFE having a melting point in the above range can be melt-extruded at 250° C. to 360° C.

The melting point is a value determined as the temperature corresponding to the maximum value on a heat-of-fusion curve as measured using a differential scanning calorimeter (DSC) apparatus (available from Seiko Instruments Inc.) at a temperature increase rate of 10° C./min.

In step (1), PCTFE is melted. PCTFE is preferably melted at a temperature equal to or higher than the melting point of PCTFE. Specifically, PCTFE is preferably melted at 250° C. to 360° C. Extrusion can be easily performed if the melting temperature is in the above range.

A method for molding the melted PCTFE into a film shape may be any known method such as extrusion and compression molding. In particular, extrusion is preferred because molding can be performed continuously. Conditions for molding PCTFE into a film nay be suitably adjusted according to the molding method and the like.

The method for producing a PCTFE film of the present invention includes step (2) of maintaining the film formed in step (1) at 100° C. to 170° C. The formed film is maintained in a predetermined temperature range, whereby a film having a high crystallinity can be obtained.

For obtaining a film having a higher crystallinity, the film is preferably maintained at a temperature of 100° C. or higher, more preferably 150° C. or higher.

The film is preferably maintained for 10 seconds or more, more preferably 30 seconds or more; and preferably for 120 seconds or less, more preferably 60 seconds or less.

The maintaining may be performed by, for example, closely contacting the formed film with a cooling roll set at 100° C. to 170° C.

The maintaining in step (2) is preferably performed by contacting the film obtained by melt-molding with a cooling roll for gradually cooling the formed film.

In the case where the maintaining in step (2) is performed by contacting the formed film with a cooling roll, the film is preferably in close contact with the cooling roll.

If there is a portion not in close contact, with the cooling roll when the film is brought to contact with the cooling roll, the portion not in close contact with the cooling roll cannot be cooled at a sufficient cooling rate, which may result in poor moisture resistance and formability. Additionally, the film may have wrinkles due to variation in the cooling rate.

Thus, the cooling roll preferably includes means for enhancing close contact between the cooling roil and the film. For example, the following methods may be employed: a method in which the film is pressed against the cooling roll using a pressing roll provided to face the cooling roll via the film; a method in which the cooling roll is electrostatically charged to closely contact the film with the cooling roll; and a method in which air between the cooling roll and the film is sucked to closely contact the film with the cooling roll. In a method in which warm air is blown to the film to closely contact the film with the cooling roll, the film will not stay in sufficiently close contact with the roll during cooling, thus failing to produce a film excellent in moisture resistance and formability.

In the production method of the present invention, the temperature of the formed film is not allowed to be 170° C. or lower during an interval between step (1) and step (2). The temperature of the film is not allowed, to be a predetermined temperature or lower during an interval between step (1) and step (2), so that the resulting PCTFE film has good tensile elongation and excellent, formability.

A method for not allowing the temperature of the film to be 170° C. or lower may be any known method such as a method in which the distance (air gap) from the die. exit in step (1) to the point where the film contacts the cooling roll in step (2) is shortened, and a method in which the film forming rate is increased. In particular, the method in which the air gap is shortened is preferred because the method can gradually cool the film.

The method tor producing a PCTFE film of the present invention further includes step (3) of cooling the film to room, temperature after the maintaining.

A method for cooling the film to room temperature after the maintaining may be any known method that can cool the film that has been maintained at the above-described temperature to room temperature. Specific methods further include a method in which the film is held by a low-temperature cooling roll. In this case, two or more low-temperature cooling rolls may be used.

The method for producing a PCTFE film of the present invention can produce a PCTFE film having low water vapor permeability and excellent moisture resistance, without heat-setting. Thus, the method is also excellent in productivity. Heat-setting is a heat treatment that is performed at about 120° C. to 230° C. to increase the crystallinity.

The PCTFE film obtained by the cooling step in step (3) is collected by, for example, winding up on a roll in a collecting step.

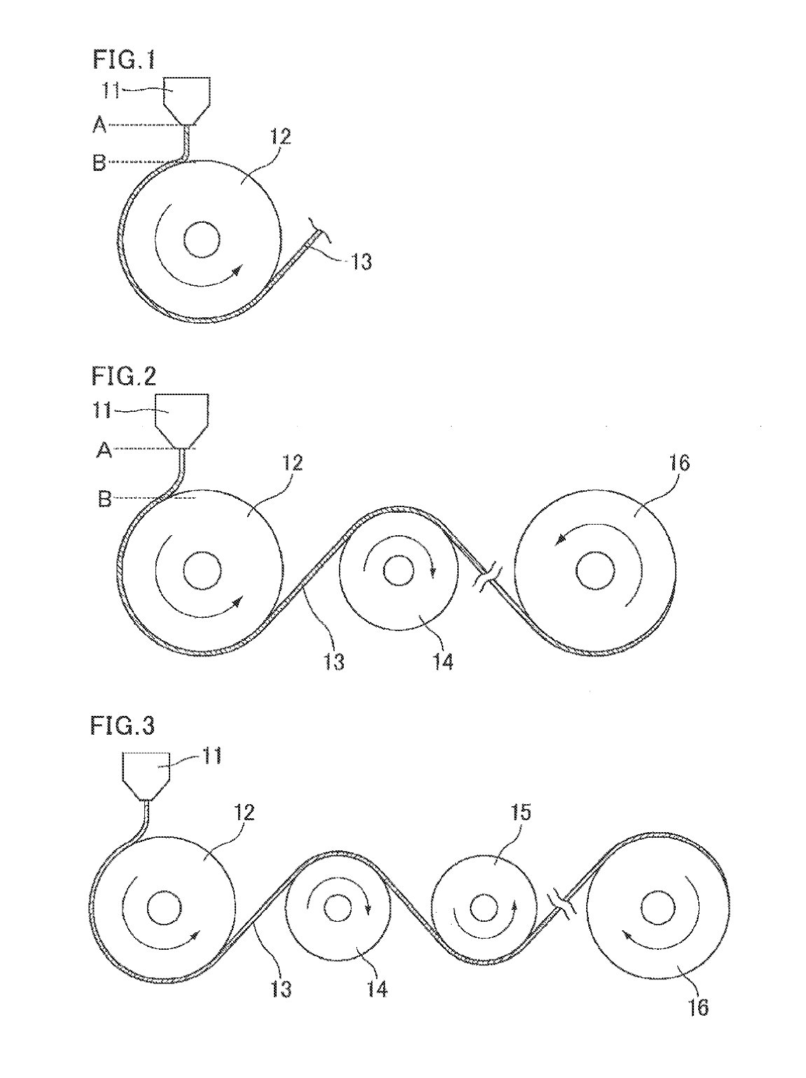

FIG. 1 shows one example of a specific embodiment of the method for producing a PCTFE film of the present invention.

As shown in FIG. 1, the melted PCTFE is extruded into a film shape from a die 11 attached to an extruder. The extruded film is cooled by being in close contact with a cooling roll 12, and maintained at a predetermined temperature. A film 13 thus cooled is cooled to room temperature through a take-up roll (now shown) and wound up on a wind-up roll (not shown).

In the production method of the present invention, the temperature of the film 13 is not allowed to be 170° C. or lower during an interval (A-B interval) from when the film 13 is extruded from the die 11 until when the film 13 is in close contact with the cooling roll 12.

FIG. 2 and FIG. 3 each show one example of an embodiment of the method for producing a PCTFE film of the present invention.

In FIG. 2 and FIG. 3, the film extruded in the same manner as in FIG. 1 is cooled by being in close contact with the first cooling roll 12, and maintained at a predetermined temperature. The film 13 thus cooled is cooled to room temperature through a second cooling roll 14, and further through a third cooling roll 15 in the case of FIG. 3, and wound up by a wind-up roll 16.

The temperature of the film 13 is not allowed to be 170° C. or lower during an interval (A-B interval) from when the film 13 is extruded from the die 11 until when the film 13 is in close contact with the cooling roll 12.

As described above, the production method of the present invention can produce a PCTFE film excellent in moisture resistance and formability.

The PCTFE film obtained by the production method of the present invention preferably has a water vapor transmission rate of 0.25 g/m²·day or less. The water vapor transmission rate in the above range results in excellent moisture resistance. The water vapor transmission rate is more preferably 0.20 g/m²·day or less, still more preferably 0.15 g/m²·day or less.

The water vapor transmission rate is a value determined by MOCON in accordance with ASTM D1249-90.

The PCTFE film obtained by the production method of the present invention preferably has a crystallinity of 35 to 70%. The crystallinity in the above range results in a film excellent in moisture resistance and formability. The crystallinity is more preferably 50% or more.

The crystallinity is a value determined by X-ray diffraction.

The PCTFE film obtained by the production method of the present invention preferably has a tensile elongation of 50% or more. A tensile elongation of 50% or more results in excellent formability. The tensile elongation is more preferably 100% or more, still more preferably 200% or more.

The tensile elongation is a value determined by a method for measuring the tensile elongation of a film in accordance with ASTM D882.

The thickness of the PCTFE film may be suitably adjusted in accordance with its usage. Usually, the thickness is preferably 15 to 200 μm.

The production method of the present invention can produce a PCTFE film excellent in moisture resistance and formability. Thus, the PCTFE film obtained by the production method of the present invention can be used as a packaging material for electrical components, electronic component, medical materials, chemical agents, and the like.

The present invention also provides a film formed from PCTFE, wherein the film has a crystallinity of 35 to 75%, a tensile elongation in its machine direction (MD) of 25% or more, and a tensile elongation in its transverse direction (TD) of 25% or more.

The crystallinity is 35 to 75%, preferably 35 to 70%. It is more preferably 40% or more, still more preferably 50% or more; and is more preferably 65% or less. If the crystallinity is too low, the moisture resistance may be insufficient. If the crystallinity is too high, manufacturing may be rendered difficult. The method for measuring the crystallinity is as mentioned above.

The tensile elongation in both machine direction (MD) and transverse direction (TB) is 25% or more, preferably 30% or more, more preferably 50% or more, still more preferably 100% or more, particularly preferably 200% or more. The upper limit is not particularly limited, and may be 300%. If the tensile elongation is too low, the film may not closely contact the mold or may break while being brought into close contact with the mold. The tensile elongation in a machine direction (MD) and a transverse direction (TD) is a value determined by a method for measuring the tensile elongation of a film in accordance with ASTM D882.

The thickness of the PCTFE film may be suitably adjusted in accordance with its usage, and may be 15 to 200 μm. The thickness is preferably 25 μm or more, and is more preferably 150 μm or less.

The PCTFE film has a water vapor transmission rate of 0.25 g/m²·day or less. The water vapor transmission rate in the above range results in excellent moisture resistance. The water vapor transmission rate is more preferably 0.20 g/m²·day or less, still more preferably 0.15 g/m²·day or less. The method for measuring the water vapor transmission rate is as mentioned above.

PCTFE forming the PCTFE film is as explained above as the PCTFE used in the production method of the present invention.

The PCTFE film may contain, as needed, additives such as an ultraviolet light absorbent, an anti-fog agent, an antioxidant, an antistatic agent, a lubricant, an anti-blocking agent, a filler, an anti-coloring agent, a pigment, and the like.

The PCTFE film can be suitably produced by the production method of the present invention.

Next, a preferred use of the PCTFE film is described.

Blister packs are used for packaging food articles, cosmetic products, pharmaceutical products, and the like. The blister packs are produced as follows: a bottom member including a depressed portion (cavity) for holding the contents is produced by vacuum forming, pressure forming, or the like; and the depressed portion for holding the contents in the bottom member is covered and scaled by a lid member made of aluminum foil or the like.

The bottom member including the depressed portion can be obtained by forming a blister packaging film into the shape of a mold by vacuum forming, pressure forming, or the like. Thus, the blister packaging film is required to have conformability to follow the shape of a mold, in addition to the moisture resistance.

The PCTFE film, which has high moisture resistance, has been used as a blister packaging film. Yet, the conventional PCTFE film has poor conformability to the shape of a mold, and is thus required to be improved. The PCTFE film is also required to have higher moisture resistance.

Compared to the conventional PCTFE film, the PCTFE film of the present invention has higher moisture resistance, better tensile elongation, and in turn, better conformability to the shape of a mold, and can thus be suitably used as a blister packaging film. Specifically, the PCTFE film can be suitably used as a blister packaging film for protecting the contents from moisture. The blister pack also encompasses “press-through package (PTP)” that includes a bottom member formed from a plastic molded body in which a depressed portion for holding the contents is formed, and aluminum foil that seals the depressed portion for holding the contents in the bottom member and that is breakable by pressure.

The PCTFE film may be formed as a laminated body in which the PCTFE film is laminated with a layer of another material. The another material may be any known material conventionally used for blister packs. Examples thereof include polyamide, polyester, and polyolefin. More specific examples thereof include polyethylene and polypropylene, poly(vinyl chloride), polyvinylidene chloride, cyclic olefin copolymer, polystyrene, and acrylic resin. Examples of the polyethylene include low density polyethylene (LDPE), linear low density polyethylene (LLDPE), linear medium density polyethylene (LMDPE), linear very low density polyethylene (VLDPE), linear ultra low density polyethylene (ULDPE), and high density polyethylene (HDPE). The low density polyethylene is preferred. Examples of the polyester include polyethylene terephthalate (PET) and glycol-modified polyethylene terephthalate (PETG). The cyclic olefin copolymer (COC) is preferably a copolymer of ethylene and norbornene. A film formed from metal-deposited polyethylene terephthalate can also be suitably used as a layer of anther material.

The PCTFE film may also be surface-treated by discharge treatment to enhance close contact with a layer of another material.

The blister pack can be suitably produced by a method including:
step (1) of melting and molding PCTFE into a film;
step (2) of maintaining the formed film at 100° C. to 170° C.;
step (3) of cooling the film to room temperature after the maintaining;
step (4) of forming the film obtained in step (3) into a bottom member including a depressed portion for holding the contents in the film; and
step (5) of bonding the bottom member and a lid member after the contents are placed in the depressed portion of the bottom member.

The above steps (1) to (3) are described as steps (1) to (3) of the production method of the present invention described above. As described above, the feature in which the temperature of the film is not allowed to be 170° C. or lower during an interval between step (1) and step (2) is also an important condition.

In step (4), a bottom member is formed which has a contour that almost matches the shape of the contents and which includes a depressed portion for holding the contents and a flange portion formed at the periphery of the depressed portion.

Additionally, in step (4), any number of depressed portions may be formed in the film (blister packaging film) obtained in step (3). The depressed portion can be formed by the following forming methods.
Heat pressure forming: a method in which a film is sandwiched between a lower mold having a hole through which high pressure air is supplied and an upper mold having a pocket-like depressed portion, and air is supplied to form a depressed portion while softening the film by heat.
Pre-heating plate pressure forming: a method in which after a film is softened by heat, the film is sandwiched between a lower mold having a hole through which high pressure air is supplied and an upper mold having a pocket-like depressed portion, and air is supplied to form a depressed portion.
Drum-type vacuum forming: a method in which after a film is partially softened by heat with a heating drum having a pocket-like depressed portion, the depressed portion of the drum is vacuumed to form a depressed portion in the film.
Pin forming: a method in which after a film is softened by heat, the film is compressed in a pocket-like mold having recesses and protrusions.
Pre-heating plug-assist pressure forming: a method in which after a film is softened by heat, the film is sandwiched between a lower mold having a hole through which high pressure air is supplied and an upper mold having a pocket-like depressed portion, and air is supplied to form a depressed portion, wherein forming is assisted by raising and lowering a plug having a protruding shape during forming.

Among these, pre-heating plug assist pressure forming, which is heat vacuum forming, is preferred because the thus-formed bottom member has a uniform thickness. Yet, the PCTFE film is excellent in formability and conformability to the shape of a mold and can thus be used in any of the above methods.

In step (5), a lid member can be fixed to the flange portion of the bottom member by heat sealing or the like.

The lid member preferably has a heat-sealable resin layer so that it can hermetically seal the contents held inside. The heat-sealable resin layer is not particularly limited as long as it is a layer that will be fused with the surface of the bottom member holding the contents during heat sealing. Examples thereof include layers containing one or more of the following components: low density polyethylene (LDPE), medium density polyethylene (MDPE), high density polyethylene (HDPE), linear low density polyethylene (LLDPE), ethylene-vinyl acetate copolymer (EVA), polypropylene (PP), ethylene-acrylic acid copolymer (EAA), ethylene-methacrylic acid copolymer (EMA), ethylene-methyl acrylate copolymer (EMAA), ethylene-ethyl acrylate copolymer (EEA), ethylene-methyl methacrylic acid copolymer (EMMA), ionomer (IO), and the like.

Additionally, for sufficiently low water vapor permeability, the lid member preferably includes a layer of metal-deposited film such as an aluminum layer or a metal layer such as a metal foil layer, and more preferably includes an aluminum foil layer.

The contents are not particularly limited. Examples thereof may include food articles, cosmetic products, pharmaceutical products, medical devices such as injection needles, and electronic components such as button batteries. The shape is also not particularly limited. Examples thereof may include a tablet.

### EXAMPLES

Next, the present invention is described with reference to examples and comparative examples, but the present invention is not limited to these examples.

### Example 1

Using a device including the die 11, the first cooling roll 12, the second cooling roll 14, and the wind-up roll 16 as shown in FIG. 2, a polychlorotrifluoroethylene (PCTFE) copolymer (100 mol % of CTFE, a melting point of 211° C., and a MFR of 0.1 g/10 min (265° C.)) was melted at a melting temperature of 250° C. or higher and supplied to a 50 mm φ T-die extruder to obtain a PCTFE film having a thickness of 25 μm at a die temperature of 360° C. to 365° C.

The rotation speed, sat temperature, and take-up speed of the cooling roll are as shown in Table 1.

Additionally, the distance of the A-B interval in the above device is about 5 cm.

The crystallinity, water vapor transmission rate, and tensile elongation of the obtained PCTFE film were evaluated by the following method. Table 1 shows one results.

### <Crystallinity>

### (X-Ray Diffraction Measurement)

The crystallinity was determined by the integrated intensity of diffraction peaks obtained by X-ray diffractometry.

A sample was attached to a sample quartz plate, and the plate was secured to a sample holder to perform an X-ray diffraction measurement using a powder X-ray diffractometer. The obtained diffraction intensity curve was fitted using analysis software such that the difference between the fitted curve and the actual curve would be 10% or less. The peaks were analyzed by peak separation. The amorphous peak was located at 2θ=17.268°, and two crystalline peaks were automatically detected. There were two crystalline peaks, and the area ratio of these peaks was determined.

Shape of the sample: a film having a size of 1.5 cm square and a predetermined thickness
Measurement device: Ultima III available from Rigaku Corporation
Measurement method: 2θ/θ method
Measurement range: 2θ=5 to 40°
X-Ray intensity: 40 kv, 120 mA
X-Ray source: CuK α-ray
Analysis software: JADE 6.0 available from Rigaku Corporation
Measurement temperature: room temperature

### (Crystallinity)

The crystallinity was calculated by the following formula using the integrated intensity of the diffraction intensity curve obtained by X-ray diffraction measurement.

### Crystallinity (%)=(S₁₉+S₂₀)/(S₁₇+S₁₉+S₂₀)×100

S₂₀: 2θ=peak area around 20°
S₁₇: 2θ=peak area around 17°
S₁₉: 2θ=peak area around 19°

### <Water Vapor Transmission Rate>

The measurement was performed in accordance with JIS-7129 (method B) using PERMATRAN-W 3/31 (available from MOCON). As for the test conditions, the temperature was 40° C. and the relative humidity (RH) was 90%.

### <Tensile Elongation (%)>

The measurement was performed in accordance with a method specified in JIS K 7127. The tensile elongation was measured in a machine direction (MD) and a transverse direction (TD). A test piece having a width of 10 mm was cut out from the film, and measurement was performed at a speed of 500 mm/min using a Tensilon universal tester (available from ORIENTEC Co., LTD.).

### Examples 2 to 7 and Comparative Examples 1 and 2

A PCTFE film was produced in the same manner as in Example 1 except that the temperature and take-up speed of the cooling roll and the film thickness were changed as shown in Table 1. Then, the crystallinity, water vapor transmission rate, and tensile elongation were evaluated. Table 1 shows the results.

### Comparative Example 3

A stretched film was produced in the same manner as in Example 3 disclosed in JP-A H08-039664, except that the draw ratio (machine direction×transverse direction) was changed to 2.5×2.5 and the elongation temperature (machine direction×transverse direction) was changed to 75° C.×75° C. The raw materials of the PCTFE were the same as those used in Example 1 above. The stretched film thus obtained was evaluated for crystallinity, water vapor transmission rate, and tensile elongation. Table 1 shows the results.

TABLE 1

| | Material | Rotation | | | Take-up | | Crystal- | Water vapor | Tensile | |
|---|---|---|---|---|---|---|---|---|---|---|
| | flow rate | speed | No.1 roll | No.2 roll | speed | Thickness | linity | transmission rate | elongation | |
| | ×10⁻³ cc/sec | (rpm) | (° C.) | (° C.) | m/min | μm | (%) | g/m²·day | MD (%) | TD (%) |
| Example 1 | 1.8 | 6 | 100 | 60 | 3 | 25 | 36.1 | 0.23 | 178 | 300 |
| Example 2 | 1.8 | 6 | 120 | 60 | 3 | 25 | 40.2 | 0.18 | 167 | 335 |
| Example 3 | 1.8 | 6 | 140 | 60 | 3 | 25 | 48.0 | 0.14 | 220 | 454 |
| Example 4 | 1.8 | 6 | 150 | 60 | 3 | 25 | 52.6 | 0.20 | 220 | 250 |
| Example 5 | 1.8 | 6 | 160 | 60 | 3 | 25 | 53.4 | 0.18 | 212 | 134 |
| Example 6 | 1.8 | 6 | 170 | 60 | 3 | 25 | 56.6 | 0.12 | 187 | 54 |
| Example 7 | 1.8 | 6 | 170 | 60 | 2 | 38 | 56.8 | 0.09 | 235 | 28 |
| Comparative | 1.8 | 6 | 90 | 60 | 3 | 25 | 30.4 | 0.25 | 158 | 335 |
| Example 1 | | | | | | | | | | |
| Comparative | 1.8 | 6 | 175 | 60 | 3 | 25 | 57.4 | Unmeasurable | Not | Not |
| Example 2 | | | | | | | | | tested | tested |
| Comparative | 1.8 | — | — | — | — | 35 | 19.0 | 0.11 | 9 | 10 |
| Example 3 | | | | | | | | | | |

### INDUSTRIAL APPLICABILITY

The PCTFE film of the present invention can be suitably used as a packaging material for electrical components, electronic components, medical materials, chemical agents, and the like.

### REFERENCE SIGNS LIST

11: die
12: cooling roll (first, cooling roll)
13: film
14: second cooling roll
15: third cooling roll
16: wind-up roll

1. A method for producing a polychlorotrifluoroethylene film, the method comprising:
step (1) of melting and molding polychlorotrifluoroethylene into a film;
step (2) of maintaining the formed film at a temperature of 100° C. to 170° C.; and
step (3) of cooling the film to room temperature after the maintaining,
wherein the temperature of the film is not allowed to be 170° C. or lower during an interval between step (1) and step (2).

2. The method for manufacturing a polychlorotrifluoroethylene film as claimed in claim 1,
wherein the maintaining in step (2) is performed by contacting the formed film with a cooling roll.

3. A polychlorotrifluoroethylene film,
wherein the film has a crystallinity of 35 to 75%,
a tensile elongation in its machine direction of 25% or more, and a tensile elongation in its transverse direction of 25% or more.

4. The polychlorotrifluoroethylene film as claimed in claim 3 which is a blister packaging film.

5. A method for producing a blister pack, the method comprising the following steps after producing polychlorotrifluoroethylene by the production method as claimed in claim 1:
step (4) of forming the polychlorotrifluoroethylene film into a bottom member including a depressed portion for holding contents; and
step (5) of bonding the bottom member and a lid member after the contents are placed in the depressed portion of the bottom member.
